(19) United States
(12) Patent Application Publication
(10) Pub. No.: US 2019/0074110 A1
(43) Pub. Date: Mar. 7, 2019

(54) MULTICORE CABLE

(71) Applicant: SUMITOMO ELECTRIC INDUSTRIES, LTD., Osaka (JP)

(72) Inventors: Masamichi NIWATA, Kanuma-shi (JP); Tatsunori HAYASHISHITA, Kanuma-shi (JP)

(73) Assignee: SUMITOMO ELECTRIC INDUSTRIES, LTD., Osaka (JP)

(21) Appl. No.: 16/114,275

(22) Filed: Aug. 28, 2018

(30) Foreign Application Priority Data
Sep. 1, 2017 (JP) 2017-168573

(51) Int. Cl. H01B 11/20; H01B 3/30; H01B 7/22

(52) U.S. Cl. CPC H01B 11/20; H01B 7/226; H01B 3/306

(57) ABSTRACT

A multicore cable includes a cable core formed by twisting a plurality of electric wires, a wrapping tape wrapped around the cable core, a shield member provided on an outer circumference of the wrapping tape, and a jacket coating an outer side of the shield member. The wrapping tape has a tape resin layer which has a tensile strength of 300 MPa or more and has a property of not melting or decomposing at 300° C., and the jacket is formed of fluororesin extrusion-molded for coating.

### CROSS-REFERENCE TO RELATED APPLICATIONS

The present application claims the benefit of priority of Japanese Patent Application No. 2017-168573, filed on Sep. 1, 2017, the content of which is incorporated herein by reference.

### TECHNICAL FIELD

The present invention relates to a multicore cable in which a wrapping tape is wrapped around a plurality of electric wires.

### BACKGROUND ART

JP-UM-A-S59-190021 discloses a structure of a multicore cable in which a tape made of a polyimide resin (PI) is wrapped around a plurality of electric wires so as to be flame retardant and low smoking.

In a case where operations of stretching or bending are frequently performed on a cable such as a cable for an endoscope, it is preferable that the cable can be sufficiently resistant to bending and stretching.

### SUMMARY

Accordingly, an object of the present invention is to provide a multicore cable having durability (bending resistance) and stretch resistance.

According to an aspect of the present invention, there is provided a multicore cable including a cable core formed by twisting a plurality of electric wires, a wrapping tape wrapped around the cable core, a shield member provided on an outer circumference of the wrapping tape, and a jacket coating an outer side of the shield member, wherein the wrapping tape has a tape resin layer which has a tensile strength of 300 MPa or more and has a property of not melting or decomposing at 300° C., and the jacket is formed of fluororesin extrusion-molded for coating.

According to the above configuration, a multicore cable having durability and stretch resistance can be provided.

### BRIEF DESCRIPTION OF DRAWINGS

FIG. 1 is a sectional view of a multicore cable according to a first embodiment of the present invention.

FIG. 2 is a sectional view of a multicore cable according to a second embodiment of the present invention.

### DESCRIPTION OF EMBODIMENTS

### Summary of Embodiments

First, embodiments of the present invention will be described.

(1) A multicore cable according to an aspect of the present invention includes a cable core formed by twisting a plurality of electric wires, a wrapping tape wrapped around the cable core, a shield member provided on an outer circumference of the wrapping tape, and a jacket coating an outer side of the shield member. The wrapping tape has a tape resin layer which has a tensile strength of 300 MPa or more and has a property of not melting or decomposing at 300° C., and the jacket is formed of fluororesin extrusion-molded for coating. Since the wrapping tape is not melting or decomposing at 300° C., even if heat is generated when extrusion-molding the jacket, damage to the wrapping tape can be avoided. Moreover, since the tensile strength of the wrapping tape is 300 MPa or more, the cable can be sufficiently resistant to stretching and bending even when operations for stretching or bending are frequently performed. Therefore, the multicore cable having durability and stretch resistance can be provided.

(2) An outer diameter of the multicore cable ranges from 0.25 mm to 1.8 mm. Although a multicore cable having a small diameter is susceptible to an influence of the heat when extrusion-molding the jacket, since the wrapping tape is not melting or decomposing at 300° C., the damage to the wrapping tape due to this heat can be avoided even when the multicore cable has the small diameter.

(3) The shield member is formed by helically wrapping a thin metal wire. The wrapping tape has the durability and the stretch resistance, and the shield member can be helically wrapped. The flexibility is improved and the outer diameter of the cable is reduced as compared with a case where the shield member is one which is braided.

### DETAILS OF EMBODIMENTS

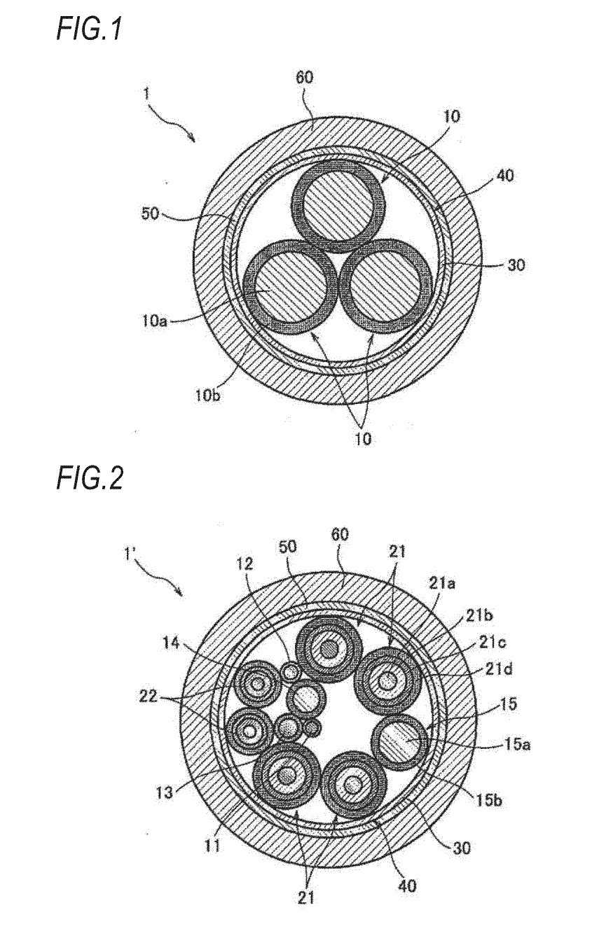

Hereinafter, specific embodiments of a multicore cable according to the present invention will be described with reference to the drawings. FIG. 1 is a sectional view of a multicore cable according to a first embodiment of the present invention. A multicore cable 1 is a cable having a small diameter (an outer diameter of the cable ranges, for example, from 0.25 mm to 1.8 mm) and is used for an endoscope, for example.

The multicore cable 1 includes a cable core 40, a shield member (also referred to as “shielding”) 50, and a jacket (also referred to as “sheath”) 60. For example, the cable core 40 shown in FIG. 1 includes therein, for example, a total of three same insulated wires 10.

The insulated wire 10 is an ultrathin wire which has, for example, an outer diameter of 0.06 mm. The insulated wire 10 includes a center conductor 10a, and an insulator 10b covering an outer circumference of the center conductor 10a. Incidentally, the insulated wire 10 may be an insulated wire having an outer diameter more than 0.05 mm to 0.1 mm. Further, the insulated wire 10 may also be an enamel wire or a twisted wire (conductor) wrapped with a tape.

The insulated wires 10 are collected in a spirally twisted state, and the wrapping tape 30 (described later) is, for example, spirally wrapped around the circumference of the insulated wires 10.

The shield member 50 is wrapped around the cable core 40 in a state where a plurality of thin metal wires (for example tin-copper alloy wires) are helically wrapped or aligned on an outer circumference of the cable core 40.

The jacket 60 coats an outer side of the shield member 50 by extrusion-molding, for example, fluororesin (FEP: tetrafluoroethylene-hexafluoropropylene copolymer).

The wrapping tape 30 has a tape resin layer which has a tensile strength (breaking strength) of 300 MPa or more and has a property of not melting or decomposing at 300° C. For example, the wrapping tape 30 is formed of a polyimide resin (PI) having a tensile strength of, for example, 340 MPa.

Meanwhile, when the wrapping tape is formed of other materials, for example, a polyethylene terephthalate resin (PET), the tensile strength is 260 MPa, and for example, when formed of a polyethylene resin (PE), the tensile strength is 20 MPa. In those cases, when the cable is frequently stretched, the cable is easily broken.

That is, in the present embodiment, if the wrapping tape 30 is formed of the polyimide resin, since the tensile strength thereof is 300 MPa or more, the cable can be sufficiently resistant to stretching and bending even when the operations of stretching or bending are frequently performed.

Further, in the present embodiment, the wrapping tape 30 formed of the polyimide resin has no melting point and has a thermal decomposition temperature of 320° C. or higher.

Meanwhile, when the wrapping tape is formed of the polyethylene terephthalate resin, the melting point is 230° C., and when formed of the polyethylene resin, the highest melting point is about 140° C.

That is, in the present embodiment, if the wrapping tape 30 is formed of the polyimide resin, the wrapping tape is not melting or decomposing at 300° C. Therefore, even if heat is applied to the wrapping tape when extruding the fluororesin to form the jacket 60, damage to the wrapping tape 30 can be avoided.

Specifically, the durability (bendability) was evaluated for the cables in the cases where the wrapping tapes 30 were respectively formed of the polyimide resin, the polyethylene terephthalate resin, and the polyethylene resin.

An evaluation test method was that a load (for example, 5 kg) was applied to a lower end of the cable, an upper portion of the cable was clamped, and the cable was bent by a bending angle of ±90° (a bending radius of 10 mm). When the center conductor in the cable core did not break after the 150,000 repeated bending, this was regarded as acceptable.

In the present embodiment, when the wrapping tape 30 was formed of the polyimide resin, the center conductor did not break, that is, the cable was acceptable.

However, the cables were not acceptable when the wrapping tape 30 was respectively formed of the polyethylene terephthalate resin and the polyethylene resin. It is considered that the melting point of the polyethylene terephthalate resin is 230° C. and the melting point of the polyethylene resin is about 140° C., so that the heat generated at the time of extrusion molding of the jacket damaged the wrapping tape, and accordingly, the center conductor could not be protected at this damaged portion.

Accordingly, if the wrapping tape 30 is formed of the polyimide resin, the multicore cable having durability and stretch resistance can be provided.

Further, since the wrapping tape 30 is formed of the polyimide resin, the shield member 50 can be one which is helically wrapped. The flexibility is improved and the outer diameter of the cable is reduced as compared with a case where the shield member is one which is braided.

FIG. 2 is a sectional view of a multicore cable according to a second embodiment of the present invention.

A multicore cable F shown in FIG. 2 is also a cable having a small diameter (an outer diameter of the cable is, for example, about 1.8 mm).

For example, the cable core includes therein a total of eleven wires which include first to fifth insulated wires 11 to 15 and first and second coaxial wires 21, 22.

The cable core 40 includes the first to fifth insulated wires 11 to 15 one by one for example.

The fifth insulated wire 15 will be described as an example, which includes a center conductor 15a having an outer diameter of about 0.32 mm, and an insulator 15b covering an outer circumference of the center conductor 15a. Incidentally, a center conductor of the first insulated wire 11 has an outer diameter of about 0.09 mm, a center conductor of the second insulated wire 12 has an outer diameter of about 0.15 mm, a center conductor of the third insulated wire 13 has an outer diameter of about 0.20 mm, and a center conductor of the fourth insulated wire 14 has an outer diameter of about 0.25 mm.

The first and second coaxial wires 21, 22 have the same structure. The cable core 40 includes, for example, four first coaxial wires 21 and two second coaxial wires 22.

The first coaxial wires 21 will be described as an example. The first coaxial wires 21 includes a center conductor 21a having an outer diameter of about 0.15 mm, and an insulator 21b covering an outer circumference of the center conductor 21a, and is provided with a shield 21c on an outer side of the insulator 21b, and a coating 21d on an outer side of the shield 21c. A center conductor of the second coaxial wire 22 has an outer diameter of about 0.09 mm. The outer diameter of the coaxial wire preferably range from 0.3 mm to 0.6 mm.

The four first coaxial wires 21 are divided into two and arranged to be in contact with an inner circumferential surface of the cable core 40. The two second coaxial wires 22 are arranged to be in contact with the inner circumferential surface of the cable core 40, and one of the second coaxial wires 22 is arranged to be in contact with the first coaxial wire 21. When one set of two coaxial wires are used for differential transmission, it is preferable to arrange the set of wires in contact with each other to eliminate a difference in line length therebetween so that the skew can be reduced.

Further, the fifth insulated wire 15 is arranged to be in contact with the inner circumferential surface of the cable core 40 in a state where both sides thereof are sandwiched by the first coaxial wires 21.

The second insulated wire 12 is sandwiched between the first coaxial wire 21 and the second coaxial wire 22, and the third insulated wire 13 or the fourth insulated wire 14 is arranged at an inner side than the second coaxial wires 22. The first insulated wire 11 is arranged at an inner side than the third insulated wire 13 or the fourth insulated wire 14.

The first to fifth insulated wires 11 to 15 and the first and second coaxial wires 21, 22 are collected in a spirally twisted state, and the wrapping tape 30 is, for example, spirally wrapped around the circumference thereof. Incidentally, a filler may be arranged inside or outside of each electric wire, and the wrapping tape 30 may be wrapped therearound.

A thickness of the polyimide tape preferably ranges from 5 μm to 15 μm, a width of the polyimide tape is preferably several times (two to nine times) the cable diameter, a winding pitch preferably ranges from 2 mm to 40 mm, and a ratio of the tape overlapping portion to the tape width preferably ranges from ⅕ to ½.

The shield member 50 is provided by helically wrapping the thin metal wires (for example, silver-plated copper alloy wires), and the jacket 60 is, for example, formed by extruding the fluororesin (PFA: perfluoroalkoxy).

The wrapping tape 30 shown in FIG. 2 is also formed of a polyimide resin, and also has a tape resin layer which has a tensile strength of 300 MPa or more and has a property of not melting or decomposing at 300° C.

The multicore cable 1′ shown in FIG. 2 can be sufficiently resistant to stretching and bending even when the operations for stretching or bending are frequently performed. Further, even if the heat is generated when extrusion molding the jacket 60, the damage to the wrapping tape 30 caused by this heating can be avoided.

It should be appreciated that the embodiments disclosed herein are in any way illustrative and non-restrictive. The scope of the present invention should be defined by the claims, and it should be appreciated that any modifications within the meaning and the scope equivalent to the claims are within the scope of the present invention.

1. A multicore cable comprising:
a cable core formed by twisting a plurality of electric wires;
a wrapping tape wrapped around the cable core;
a shield member provided on an outer circumference of the wrapping tape; and
a jacket coating an outer side of the shield member,
wherein the wrapping tape includes a tape resin layer which has a tensile strength of 300 MPa or more and has a property of not melting or decomposing at 300° C., and
wherein the jacket is formed of fluororesin extrusion-molded for coating.

2. The multicore cable according to claim 1,
wherein an outer diameter of the multicore cable ranges from 0.25 mm to 1.8 mm.

3. The multicore cable according to claim 1,
wherein the shield member is formed by helically wrapping a thin metal wire.
